(19) United States
(12) Patent Application Publication
(10) Pub. No.: US 2009/0068624 A1
(43) Pub. Date: Mar. 12, 2009

(54) LETTER DEVELOPMENT CARDS

(76) Inventor: Toni Schulken, Charlotte, NC (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/205,295

(22) Filed: Sep. 5, 2008

Related U.S. Application Data
(63) Continuation-in-part of application No. 11/853,988, filed on Sep. 12, 2007.
Application No. 11/853,988 is a continuation-in-part of application No. 11/853,411, filed on Sep. 11, 2007.

(51) Int. Cl. G09B 19/22

(52) U.S. Cl. 434/129

(57) ABSTRACT

A card set including a plurality of letter or number development cards. Each card includes opposed instruction and challenge sides. Each instruction side has instruction indicia relating to the writing of a particular letter or number associated with the card. Each challenge side has visual indicia which indirectly identifies the particular letter or number and cues the user to write the particular letter or number. The challenge side of the card lacks any indicia that directly identifies which particular letter or number is associated with the card.

This application is a continuation-in-part of U.S. patent application Ser. No. 11/853,988, entitled COLOR CODED LETTER GUIDE, filed on Sep. 12, 2007, the entire contents of which are incorporated by reference, and is a continuation-in-part of U.S. patent application Ser. No. 11/853,411, entitled LETTER GUIDE SHEET, filed on Sep. 11, 2007, the entire contents of which are hereby incorporated by reference.

The present invention is directed to a system for developing a user's writing skills, and more particularly, to a system for developing a user's letter and/or number writing skills.

### BACKGROUND

As children and other users learn to write letter and numbers, it is important to teach the proper form of the letter or numbers, as well as proper stroke direction (i.e. directionality of letter and number formation). Moreover, users should learn continuity of letter and number formation which results in increased legibility and leads to an easier transition to cursive writing.

### SUMMARY

In one embodiment, the invention is a card set including a plurality of letter or number development cards. Each card includes opposed instruction and challenge sides. Each instruction side has instruction indicia relating to the writing of a particular letter or number associated with the card. Each challenge side has visual indicia which indirectly identifies the particular letter or number and cues the user to write the particular letter or number. The challenge side of the card lacks any indicia that directly identifies which particular letter or number is associated with the card.

### BRIEF DESCRIPTION OF THE DRAWINGS

FIG. 1 is a front view of a card for the letter “c”;

FIG. 2 is a back view of the card of FIG. 1;

FIG. 3 is a front view of a card for the letter “x”;

FIG. 4 is a back view of the card of FIG. 3;

FIG. 5 is a front view of a letter grouping card;

FIG. 6 is a back view of the letter grouping card of FIG. 5;

FIGS. 7-14 are front and back views of various other letter grouping cards;

FIG. 15 is a front view of a card for the letter “L”;

FIG. 16 is a back view of the card of FIG. 15;

FIG. 17 is a front view of a card for the letter “E”;

FIG. 18 is a back view of the card of FIG. 17;

FIG. 19 is a front view of a letter grouping card;

FIG. 20 is a back view of the letter grouping card of FIG. 19; and

FIGS. 21-34 are front and back views of various other letter grouping cards;

### DETAILED DESCRIPTION

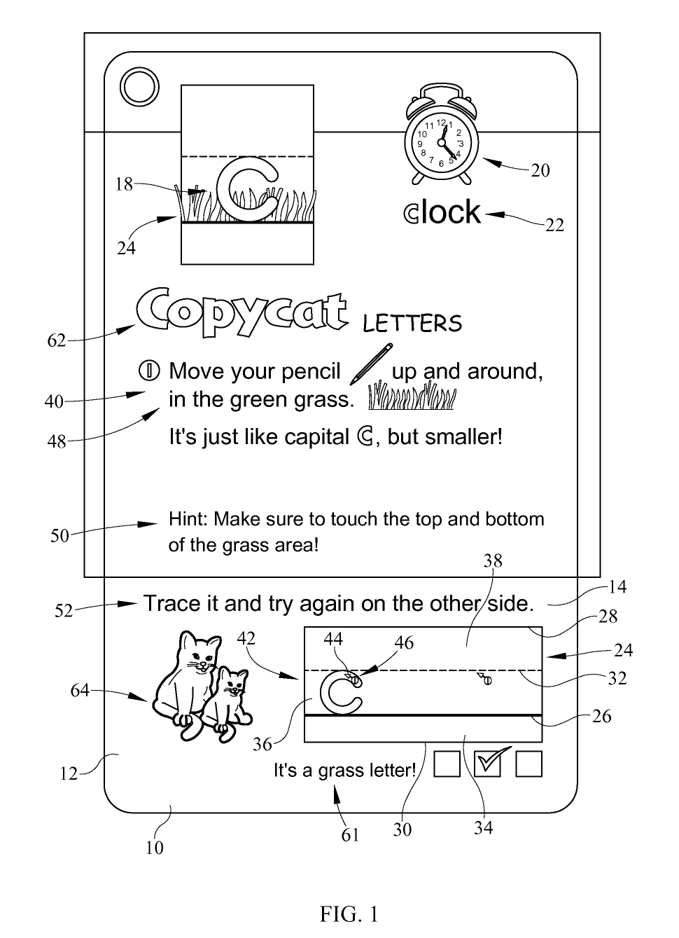

The system of the present invention includes various flash cards having instructions and/or indicia to aid the user in writing skill development. A plurality of each type of flash cards, each having varying indicia, may be grouped and/or sold together to allow the user to develop skills through repetition and use of each type of cards. The cards may be index-card sized cards (i.e., 3″×5″, 4″×6″, 3¼″×5¼″ etc.), and thus the cards in the attached FIGS. 1-34 are shown to scale, at least in one embodiment. Each card may have a surface area of less than about 25 square inches.

Each card may include a sheet-like body 12. The cards/sheet-like material 12 can be made of from any of a wide variety of materials but in one case are made of, or coated with, a non-water absorbent material, such as plastic, polymers, polypropylene, etc. In this manner the cards can be written on with a marker or the like and be re-used in a write-on/wipe off manner. Alternately, the cards/sheet-like material may be made of a cellulose-based or pulp-based paper such that the cards are generally water absorbent and can be written upon by a wide variety of media (i.e. pens, pencils, markers, crayons, etc.). The cards may be relatively thin, and may have a thickness of about 0.5 mm or less.

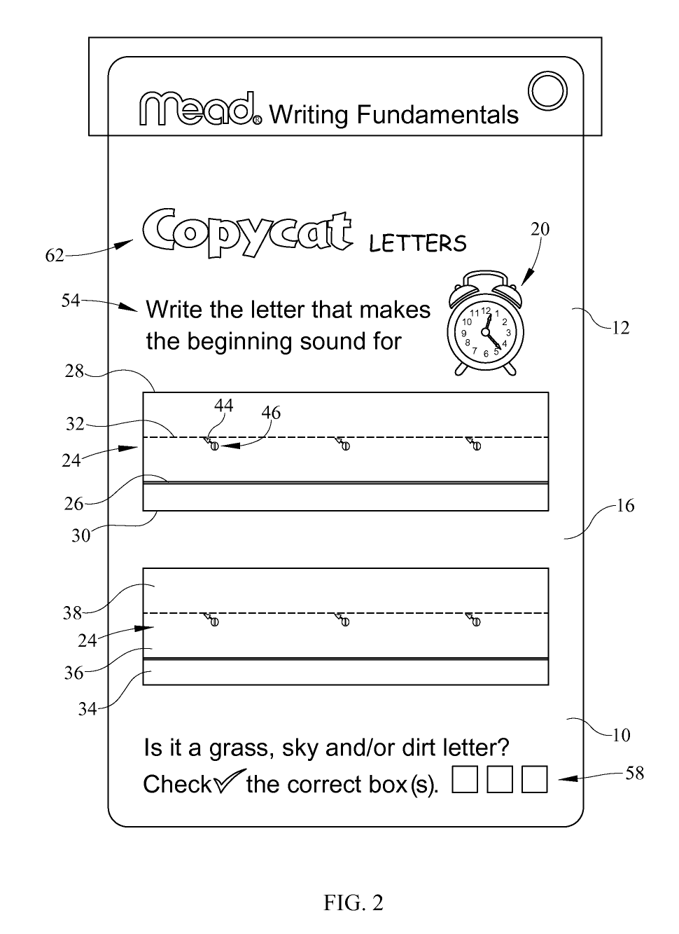

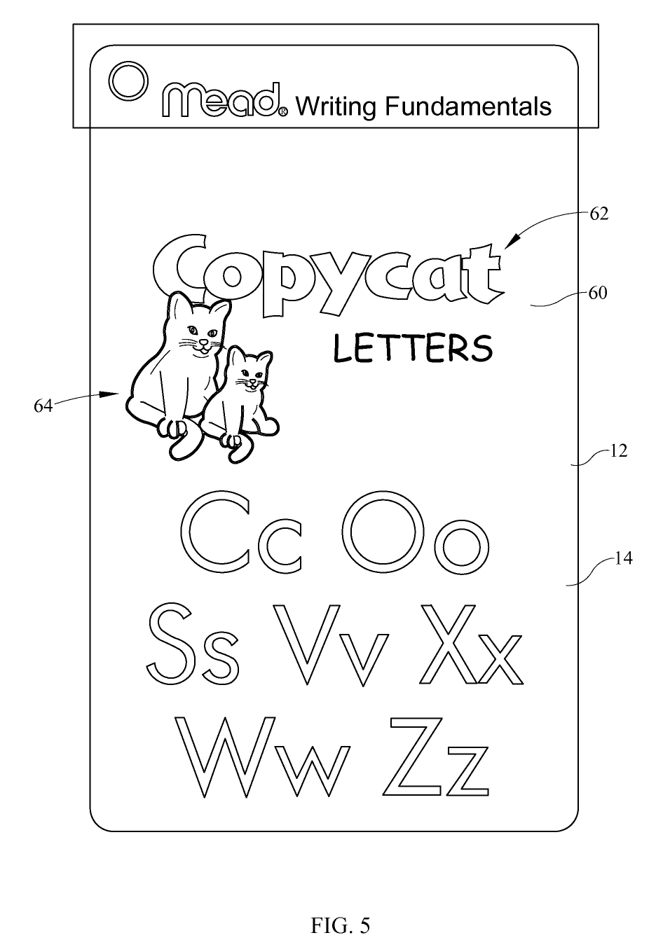

The cards 10, 60 shown in FIGS. 1-14 may be termed lower-case cards and include lower case letter development cards 10 (FIGS. 1-4) and lower case letter grouping cards 60 (FIGS. 5-14), and present challenges and skill development activities relating to the writing of lower case letters with proper formation and alignment on primary paper. Each card 10, 60 may be double-sided, with text and/or indicia on each side thereof. For example, FIG. 1 illustrates the instruction side 14 of a single card 10, and FIG. 2 illustrates the challenge, or opposite side 16 of that card 10. The instruction 14 and challenge 16 sides of each card 10, 60 may be generally differently colored. For example, in one embodiment, the instruction 14 side of each card 10 generally has a yellow background color, and the challenge side 16 of each card 10 generally has a white background color. However, the instruction 14 and challenge sides 16 of a card 10 (or a card 60) may be of the same color, or may be differentiated by any of a wide variety of other means, such as patterns, shading, texture, etc.

Each letter development card 10 may addressed to a single letter or number. For example, the card 10 shown in FIGS. 1 and 2 is directed to the letter “c”. The instruction side 14 of each card 10 includes a variety of indicia, including an introduction 18 of the letter that is the subject of that particular card 10. In this case, for example, referring to FIG. 1, it can be seen that the letter “c” is printed at the top of the card 10. The instruction side 14 of the card 10 also provides a visual representation 20 of an item (such as a household item, animal, toy), place, activity, concept or the like, which serves as a phonetic connection to the letter of that card, or has a name that begins with the letter of that card. In this case, the visual representation 20 takes the form of a clock.

Appropriate labelling text 22 (i.e. the word “clock”) is provided adjacent to the visual representation 20 so that the form and spelling of the associated word is also presented to the user. Moreover, the first letter of the labelling text 22 (in this case, the letter “c” of the word “clock”) may be provided in a different form, format, spacing, color, texture, etc., from the rest of the labelling text 22. In FIG. 1, for example, the first letter (“c”) in the word “clock” may be provided in a bold, red font to draw attention to that letter.

A writing space 24 may be provided on the instruction side 14 of the card 10. In the illustrated embodiment, the writing space 24 includes a baseline 26 and an ascender line 28 positioned above the baseline, and a descender line 30 positioned below the baseline 26. An intermediate line 32 (which is a dotted line in the illustrated embodiment) may be positioned between the baseline 26 and the ascender line 28. The lines 26, 28, 30, 32 are provided to guide the user in his or her writing thereon.

The differing spaces defined by the baseline 26, ascender line 28, descender line 30 and intermediate line 32 may be colored or shaded to guide letter formation and alignment. In particular, the lower portion 34 of the writing space 24 (positioned between the baseline 26 and descender line 30) may be colored brown (representing dirt or earth). The middle portion 36 (positioned between the baseline 26 and the intermediate line 32) may be colored green (representing plants or vegetation, such as grass). Finally, the upper portion 38 (positioned between the intermediate line 32 and the ascender line 28) may be colored blue (representing sky).

In this manner, the colored portions 34, 36, 38 provide vertical orientation within each writing space 24 that is intuitive and universally understood since the sky is above vegetation, which is in turn above soil. The use of brown, green and blue colors also presents a brightly colored portions to attract and retain the attention of the user. The introductory letter 18 on the instruction side 14 can also be written on a writing space 24 using the same coloring scheme. Besides the use of colors, other visual indicia, such as clouds, airplanes, etc., leaves, grass, etc., and earthworms, roots, etc. may be provided in the associated colored portion 34, 36, 38 to further reinforce the presented concepts. The use of colors in the writing spaces and other features noted herein are described in more detail in U.S. patent application Ser. No. 11/853,988, entitled COLOR CODED LETTER GUIDE, filed on Sep. 12, 2007, the entire contents of which are have been incorporated by reference.

The instruction side 14 of each letter development card 10 may include a traceable version 42 of the letter on the writing space 24. The traceable version 42 may be presented as a relatively thin or light line, a shaded line, a non-black line and/or an incomplete line which is printed in dotted or dashed format. The traceable version 42 may be formatted in this manner so that a user can write over the traceable version 42 and easily distinguish which portions of the traceable version 42 are pre-printed, and which portions have been written by the user. Each letter development card 10 may also include guide arrows or other directional cues 44, and associated numerical cues 46 (which together or separately constitute a writing stroke or starting cue), on the writing space 24. The directional cues 44 and numerical cues 46 may be superimposed on the traceable version 42, or could be placed adjacent to the traceable version 42.

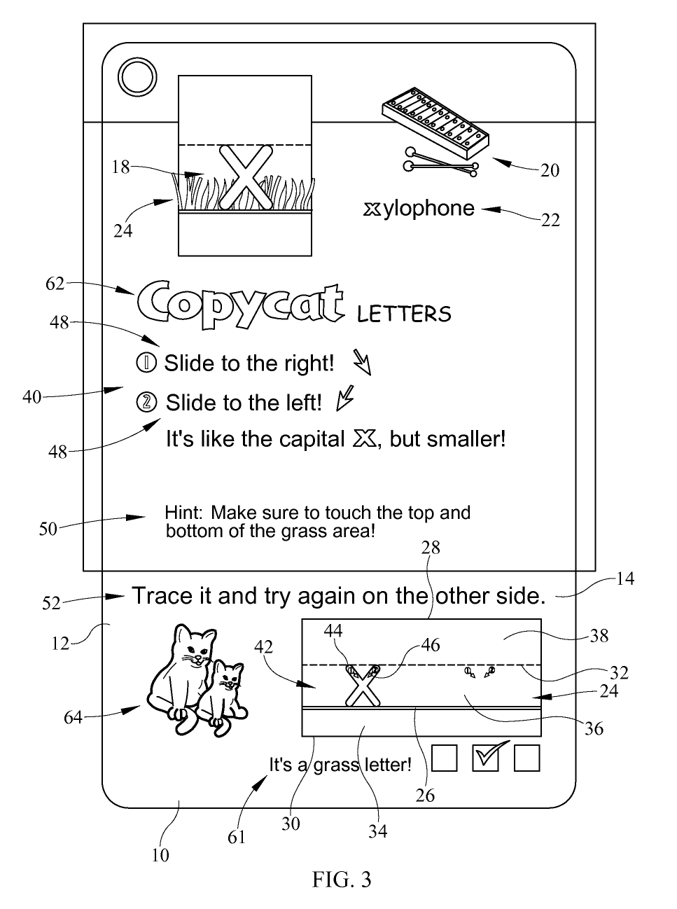

As best shown in, for example, FIG. 3, instruction indicia 40 is printed on the instruction side 14 of the card 10. The instruction indicia 40 may include discrete ordered steps that teach or cue a user in the proper writing strokes to write the associated letter or number. The instruction indicia 40 encourages a user to learn proper directional sequence for letter or number writing. In the illustrated embodiment, each step of the instruction indicia 40 is numbered and associated with a color, and the associated portion of the traceable version 42 of the associated letter is correspondingly numbered and associated with a color.

For example, in FIG. 3, the first part of the instruction indicia 40 (and/or the associated number “1”) is black or otherwise associated with the color black. Correspondingly, the upper-left to lower-right portion of the traceable version 42 of the letter “x” (which corresponds, and is located adjacent to, directional arrow 44 labeled “1”) is also black or otherwise associated with the color black. The second part of the instruction indicia 40 (and/or the associated number “2”) is red or associated with the color red, and the upper-right to lower-left portion of the traceable version 42 of the letter “x” is red associated with the color red. In this manner a connection between instruction indicia 40 and the traceable version 42 is provided by colors and numbers, although patterns, indicia or the like may be utilized instead of or in addition to color. A similar connection may be made between the instruction indicia 42 and the sample version 18 of the letter.

In this embodiment, in the traceable version 42 of the letter each differing stroke is presented in a different color. Thus a user knows that when there is a change in color, a new writing stroke is presented and the user should pick up his or her writing instrument to start the next writing stroke. Conversely, when there is no change in color, the user is cued to keep their writing instrument on the sheet/card, thereby reinforcing writing continuity.

The instruction indicia 40 may include narrative text 48 that reinforces the directional cues. For example, the narrative text associated with step 1 on FIG. 3 indicates the user should “slide to the right.” Step 2 cues a user to “slide to the left.” Thus, the narrative text 48 of the instruction indicia 40 may describe an object or activity that is symbolic of the associated motor pattern or writing step to be carried out by the user. The narrative text 48 of the instruction indicia 40 also provides a “story” which is easy for the user to learn and remember, as opposed to having to rely upon rote memorization to learn the shapes and stroke order of each letter or number. For example, when writing the letter “x” the user need only remember to “slide” to the right and to the left, and the shape, strokes, and stroke order can all be easily and naturally recalled. Accordingly the letter development cards 10 utilize a multi-sensory approach to teaching letter or number formation which utilizes color and other visual and non-visual cues.

The instruction indicia 40 may also refer to the color scheme inherent in the color of the writing spaces 24 to cue letter placement/alignment. For example, the narrative text 48 in FIG. 1 encourages the user to move his or her pencil “in the green grass,” referring to the middle portion 36 of the writing space 24. A visual representation of grass is also provided in that portion of the instruction indicia 40. Thus, visual and/or color representations of grass, sky or dirt may be included in the instruction indicia 40 to increase a user's correlation between the instruction indicia 40 and the vertical frame of reference in the writing space 24, which cues letter placement in the writing space 24. The instruction side 14 of each letter development card 10 may include a hint 50 relating to the writing of the appropriate letter, and encouragement 52 to try writing the letter on the opposite side of the card.

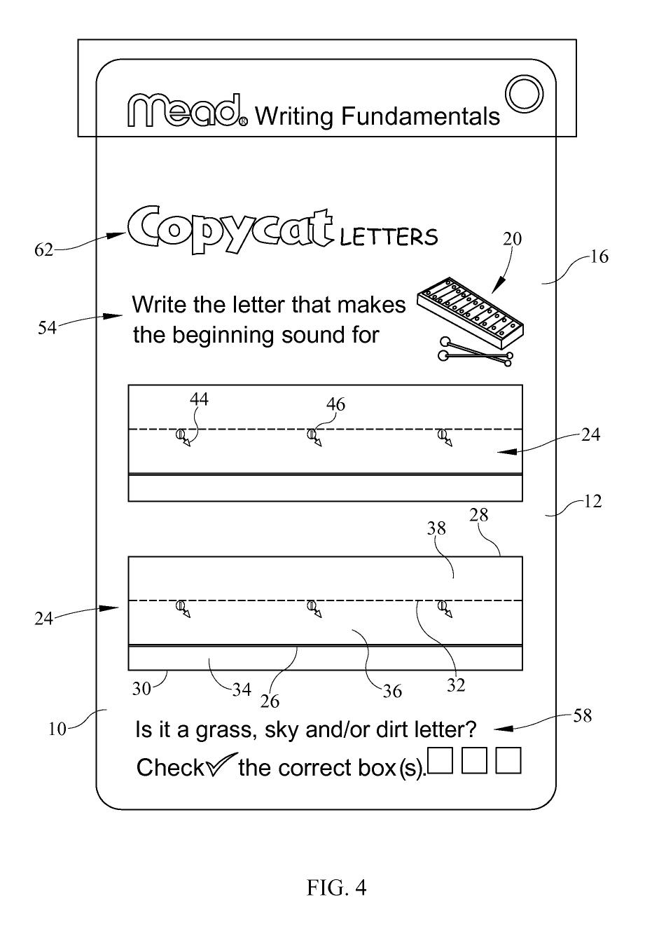

The challenge side 16 of each letter development card 10 (examples of which are shown in FIGS. 2 and 4) may include question/challenge indicia 54 relating to letter/number identification. For example, the challenge indicia 54 in the card 10 of FIG. 2 challenges a user to write the letter that makes the beginning sound for a visually represented clock 20. Thus, the challenge side 16 of the cards 10 provide visual and/or phonetic cues to the user to write the particular letter associated with that card 10. The challenge side 16 of the card 10 may lack indicia that directly informs the user of letter associated with the card 10 to not provide a direct or prominent visual model of the letter, instead relying upon the challenge indicia 54 to prompt the user to write the desired letter. As will be described in greater detail below, the instruction side of each card 10 may include indicia which identifies the letter, which the user can reference to check his or her answer to the challenge indicia 54.

The user is cued to write the desired letter cued by the challenge indicia 54 on the writing space 24 on the challenge side 16 of the card 10. In the illustrated embodiment, the writing spaces 24 on the challenge side 16 of the card 10 include directional cues 44 and numerical cues 46 to prompt the user to begin letter/number writing at the appropriate location on the writing space 24. However, the challenge side 16 of the card 10 may lack the instruction indicia 40 for actual letter formation to further challenge the user. In the illustrated embodiment, only the initial directional cue 44 and numerical cue 46 are provided such that only the start of the first writing stroke is cued. In this case the user must recall the rest of the first writing stroke, and subsequent writing strokes (if any), which even further challenges the user. However, the placement and direction of the directional 44 and numerical cues 46 provide some cues to the user who is attempting to identify the letter cued by the challenge indicia 54. For example, in the card 10 of FIG. 2, the directional 44 and numerical 46 cues reveal that the associated letter is properly written with an up-and-to-the-left stroke beginning immediately below the intermediate line 32

The challenge side 16 of each card 10 may also include a challenge/question 58 relating to use of the color coding for letter alignment/placement in the writing spaces 24. In particular, each card 10 may question the user whether the letter associated with that card 10 is a “grass, sky and/or dirt” letter; i.e. whether any portions of the letter are placed into the green 36, blue 38 and/or brown 34 portions of the writing space 24. This challenge 58 therefore reinforces the vertical alignment and relative positioning concepts presented in using the color coded writing spaces 24. The answer 61 to the challenge relating to whether a letter is a “grass, sky and/or dirt” letter may be provided on the instruction side 14 of the card 10. The challenge 58 thus reinforces to the user the importance of letter alignment.

In order to use the cards, in one case a user may begin with the challenge side 16 of the card 10, which challenges the user to identify the appropriate letter. Since the letter the user is cued to write is not directly presented to the user, the user must recall the shape of the letter and the writing strokes on their own (although some minimal cues are provided as to where the letters starts in the form of the directional 44 and numerical 46 cues). The user can then review the instruction side 14 of the card 10 to check their answers. The user can then return to the challenge side 16 of the card 10 to continue practice writing the letter multiple times. Moreover, the grass/sky/dirt challenge 58 provides an additional check on the user's vertical alignment of the letters. In this manner the card 10 provides a multisensory approach to letter writing and increases visual memory skills, visual motor integration, and visual and motor sequential memory skills. This is in contrast to many existing systems in which the user is cued to learn letter writing skills through simple modeling and repetition.

In another form of use, a user may first review the instruction side 14 of each card 10 and review the instruction indicia 40 to become familiar with the proper writing strokes for that number/letter, and practice writing the associated number/letter. The user may then flip to the challenge side 16 of the card 10 to continue practicing writing the letter/number with less cuing. This form of use emphasized learning letter formation through direct instruction without a self-check feature, and may be of benefit to a user who has not yet received basic writing instruction. The cards 10 may be reviewed by a user individually, or with other users in a group, or with an instructor/parent. For example, the stories/narratives and other instructions 40 may be read to the user by a parent, teacher, or the like, which allows a user to auditorily receive letter or number formation instruction, along with pictorial cues which increases retention. In one case, the teacher/instructor may show the user the challenge side 16 of a card 10, and quiz the user to identify and write the associated letter. If the user is unable to identify the letter, a teacher/instructor may read the information on the instruction side 14 of the card 10, or show the instruction side 14 to the user. The user may then practice writing the letter on the instruction side 14 of the card, and then try completing the challenge side 16, thereby increasing the likelihood of success and building the user's confidence.

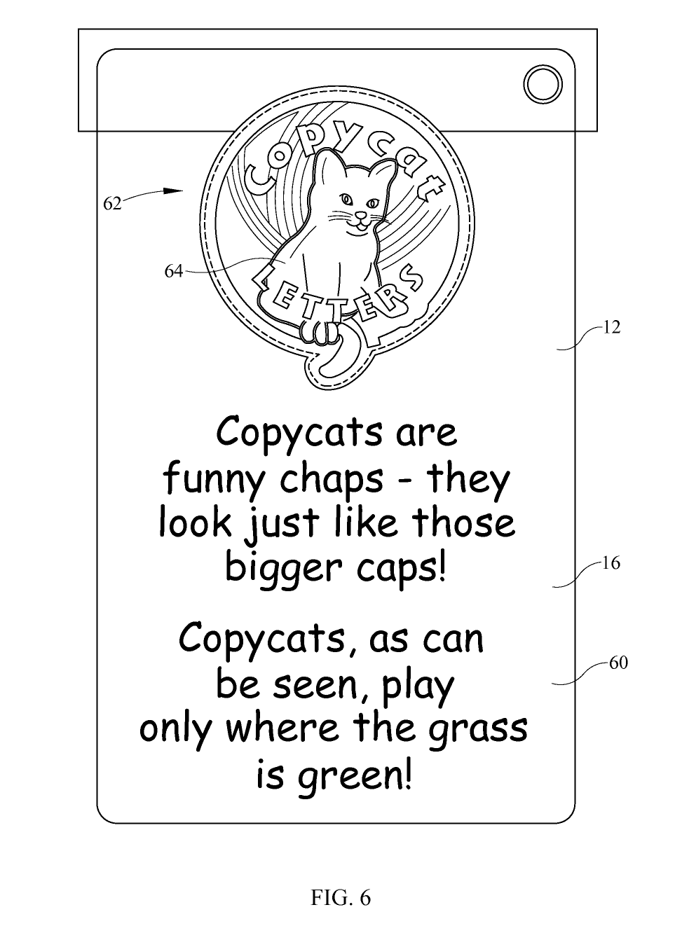

The letter development cards/letters may be grouped into groupings having common characteristics. For example, FIGS. 5 and 6 each illustrate a side of a letter grouping card 60 which introduces the letters in that particular grouping (in this case, the letters c, o, s, v, x, w and z). The grouping card 60 also provides a title 62 for the letters in that grouping (“copycat” letters in the card of FIGS. 5 and 6), and a symbol 64 associated with that grouping (i.e. the visual representation of a large cat and a small cat). Each letter development card 10 may include the title 62 and/or symbol 64 of the grouping to which that card belongs (see FIGS. 1-4).

The grouping card 60 may also describe common attributes of the letters in that grouping. For example, as noted in FIG. 6, all of the letters in the copycat grouping consist of lowercase letters that have the same basic shape and format as the associated uppercase letter, with the exception of being smaller and placed within the middle (green) portion 36 of the writing space 24 (or at the x-height), rather than the middle (green) portion 36 and upper 38 (blue) portion. Each grouping card 60 may also refer to the positioning of the letters relative to the writing spaces 24 (i.e. “Copycats, as can be seen, play only where the grass is green”). Letter development cards 10 for each of letters c, o, s, v, x, w and z of the grouping card may be presented in order after the grouping card 60 is presented. Alternately, the letter development cards 10 may be presented out of order to provide a further challenge to the user.

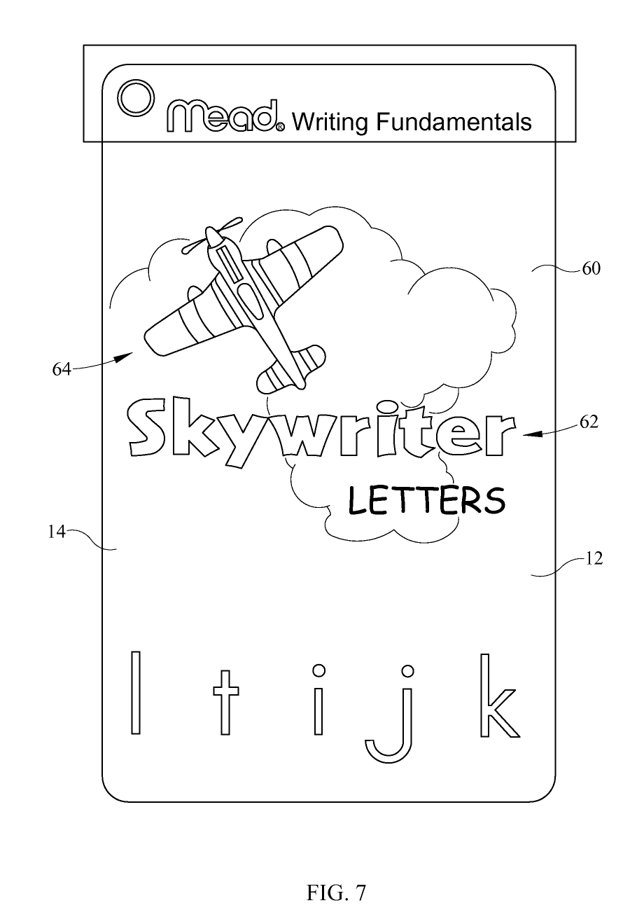

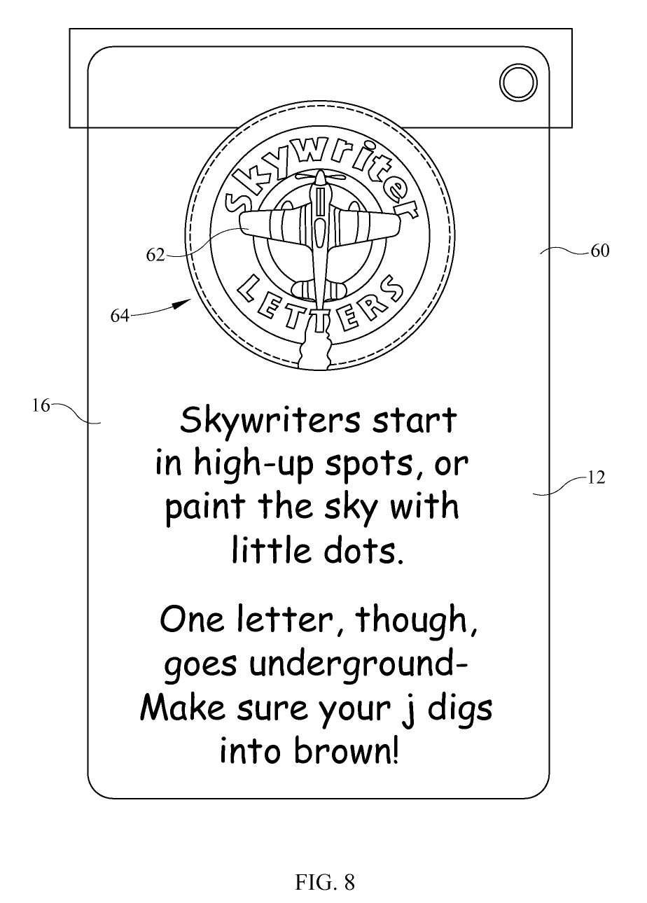

FIGS. 7 and 8 illustrate a grouping card 60 which introduces the letters in a second grouping which may be termed the “skywriter” group and consists of the letters l, t, i, j and k. All of the letters in this grouping are written with a relatively high starting point, or have superscript dots, and thus can be taught using similar technique or motor pattern. All of the letters in this second grouping also have components that are ascenders which relates to the name of the grouping (i.e. “skywriters”) in which the letter ascends into the upper portion 38 (or blue/sky space) of the writing space 24. Moreover, all the pre-writing components of the skywriter letters include predominately vertical and horizontal lines, although the letter j has a curve and the letter k has oblique components.

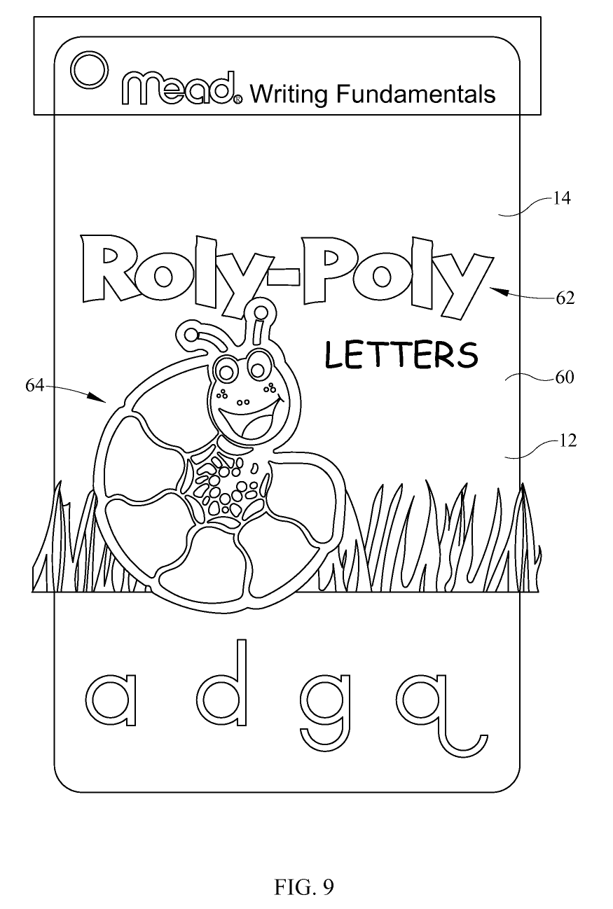

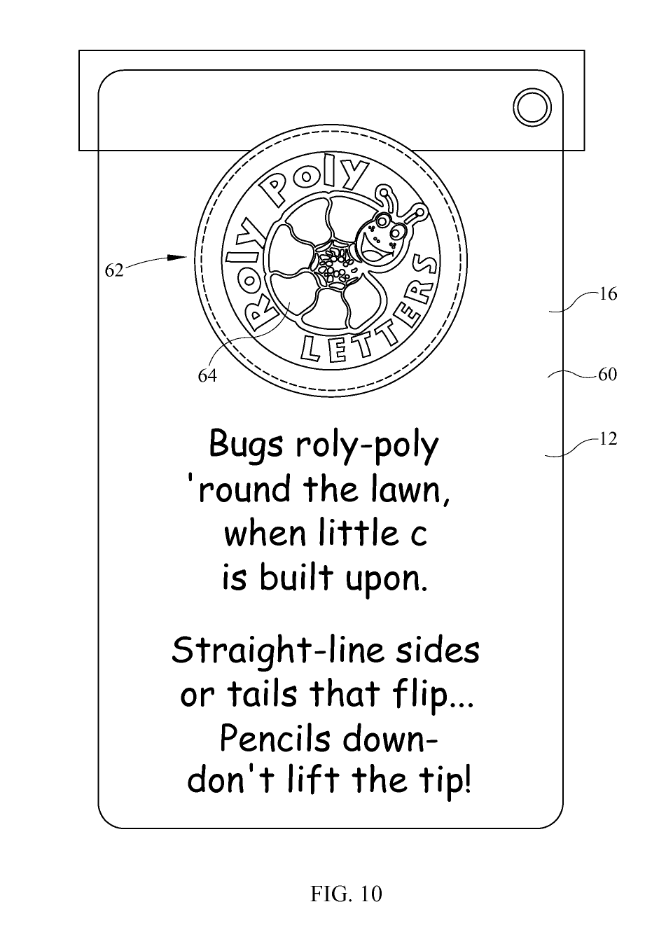

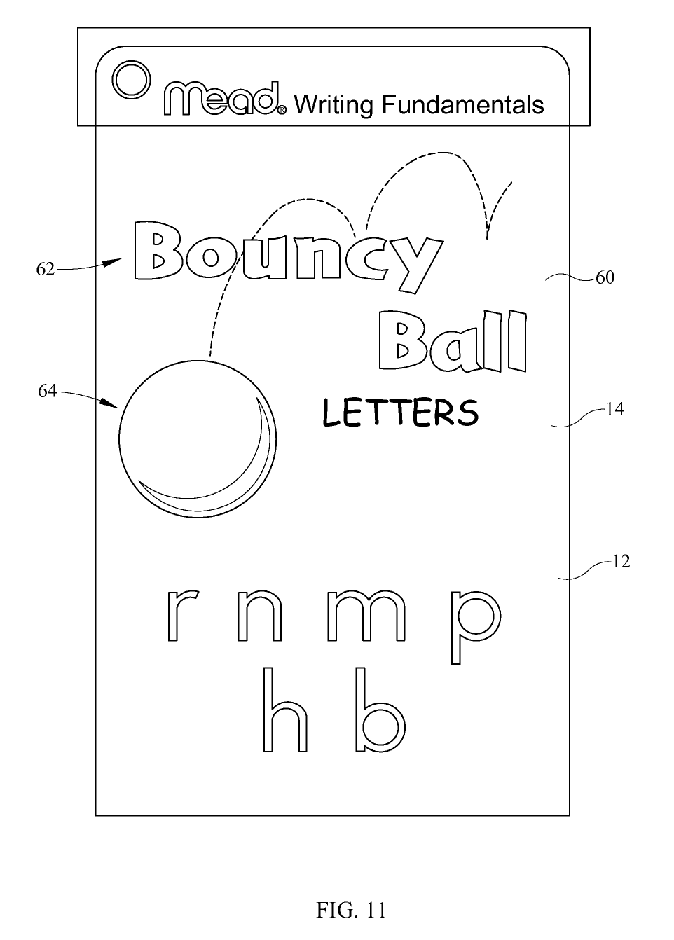

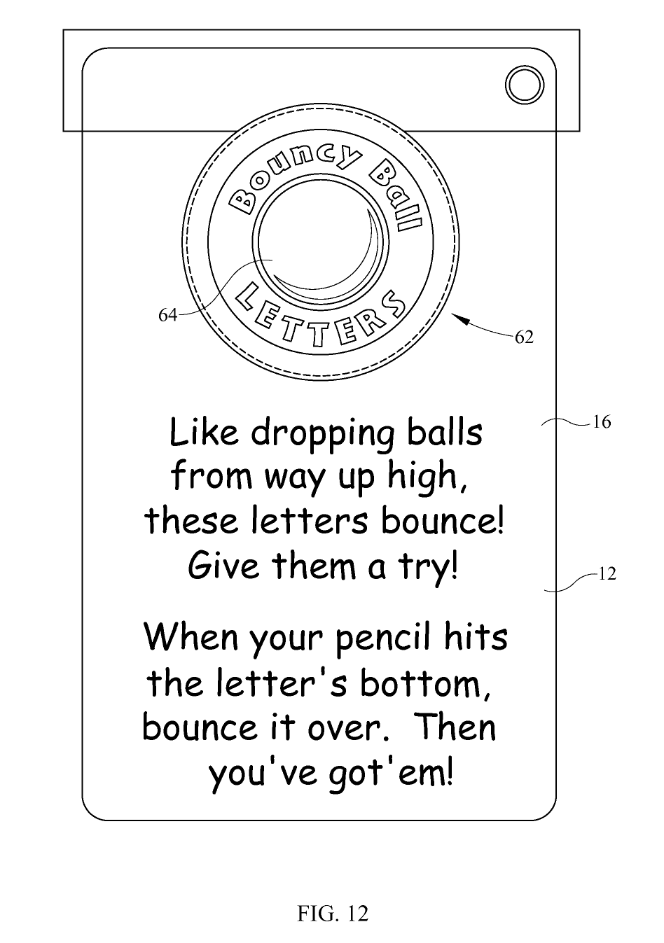

A total of five letter groupings may be utilized. Besides the two groupings described above, the third grouping may be termed the “roly poly” letters and consists of the letters a, d, g and q (as shown by the card on FIGS. 9 and 10). These letters introduce the more difficult motor patterns of retracing. In particular, all the letters in this grouping begin with a curve, and the writing instrument is then moved up and retraced back down without lifting the writing instrument. The fourth grouping may be termed the “bouncy ball” letters and consist of the letters r, n, m, p, h and b (as shown by the card 60 on FIGS. 11 and 12). The letters of this grouping have similar components and forming steps, such as retracing. However, the letters of the fourth grouping have a unique motor pattern of down, up, and over to the right without lifting the writing instrument.

The “roly poly” and “bouncy ball” groupings contain letters that are often incorrectly formed by users in a segmented manner (i.e. lifting the writing instrument during letter formation). Writing the letters in a segmented manner decreases efficiency, legibility, and proper directionality of the letters. Thus, the cuing used on the cards 10 for the letters in these groups helps a user to avoid these problems by teaching continuity of letter formation.

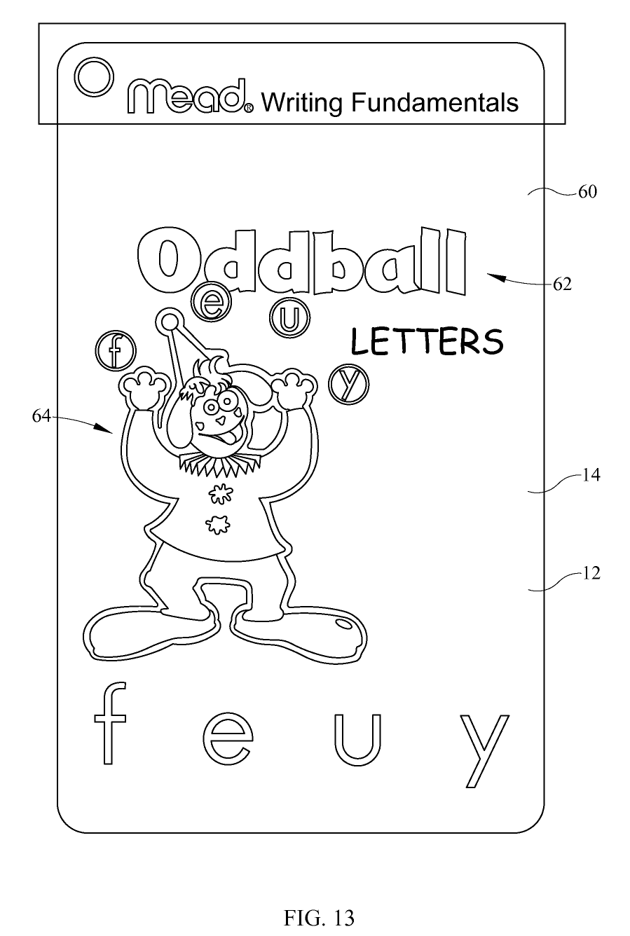

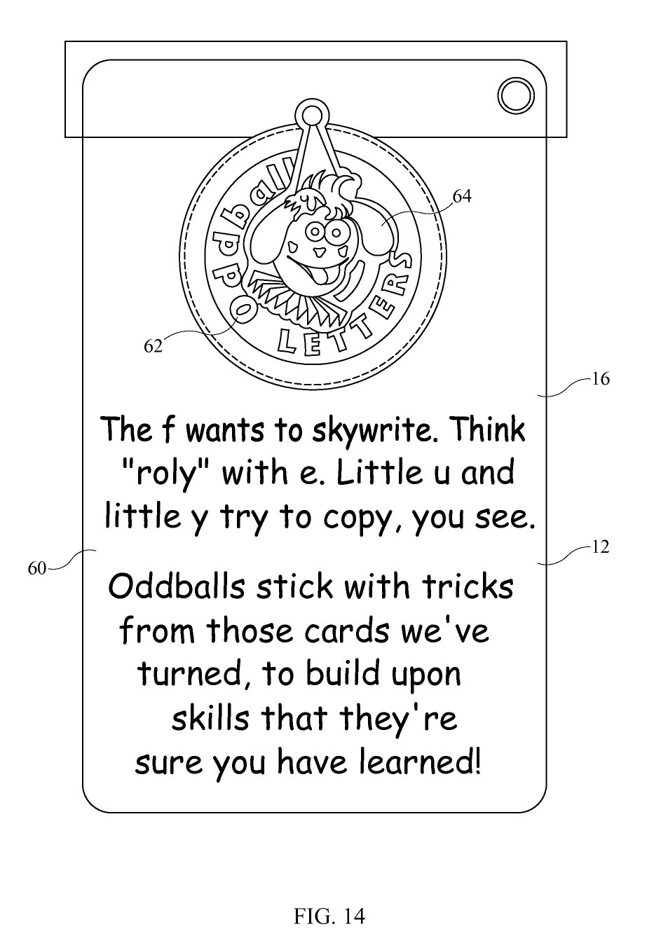

Finally, the fifth grouping of letters may be termed the “oddball” letters and consist of the letters f, e, u and y (as shown by the card 60 in FIGS. 13 and 14). The letters in this grouping are written with relatively unique motor patterns, but have some similarities to the letters of the other four groupings, which similarities may be specified in the individual letter development cards 10 for each particular letter. These five letter groupings are based on similar motor patterns, line placement (letter alignment) and the use of similar pre-writing components for the letters within that group.

The cards 10/60 may be arranged, and/or a user may be instructed, to work through each grouping in the order presented above. The groupings may be arranged in this order to present progressively more challenging groupings to a user, and to allow a user to develop basic writing skills before adding more sophisticated writing skills to the skills required by the previous grouping. Alternately, the cards 10/60 can be worked in various other patterns to provide more of a challenge to the user and test the generalization of letter formation skills without the guidance provided by grouping letters of similar motor patterns together.

A letter development card 10 for each lower case letter in the alphabet may be provided. Each card 10 may present challenges and skill development activities relating to the writing of lower case letters and may be packaged and/or sold together. In addition, letter development cards 70 and letter grouping cards 72 that relate to the writing of upper case letters may be packaged and/or sold separately from the lower case letter cards 10, 60, (although, if desired, the upper and lower case cards may be packaged and sold together). Each of the upper case cards 70, 72 may be made of the same materials (such as the sheet-like body 12) and have other properties as the cards 10/60 described above.

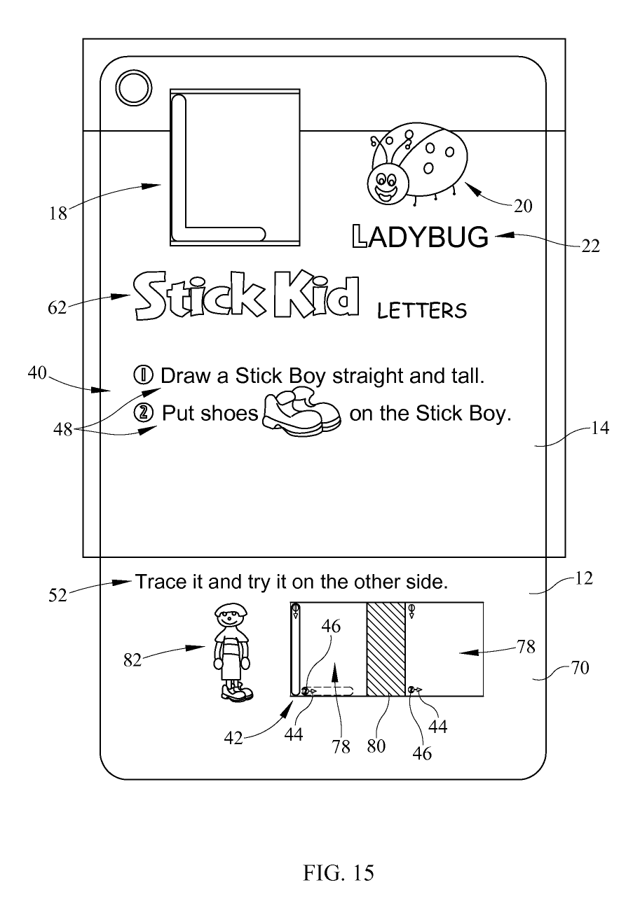

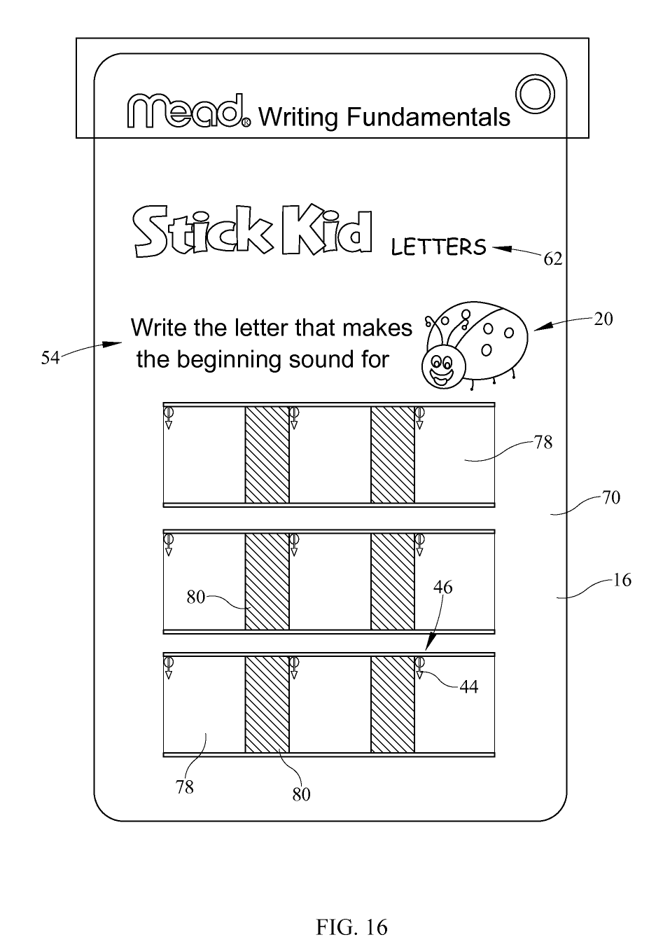

Each upper case card 70, 72 may be double-sided, with text and/or indicia on each side thereof. For example, FIG. 15 illustrates the instruction side 14 of a single upper case letter development card 70, and FIG. 16 illustrates the opposite, challenge side 16 of that card 70. The instruction 14 and challenge sides 16 may be differently colored or otherwise differentiated, as outlined above in the context of the lower case letter development cards 10.

As shown in FIG. 15, each capital letter development card 70 may include an introduction letter 18, a visual representation 20, labeling text 22, and sequential instruction indicia 40 in generally the same manner as the lower case letter development cards 10 described above. For example, in FIG. 15, the capital letter “L” is introduced. A visual representation 20 of a ladybug and the labelling text 22 “LADYBUG” is presented, with a bold and/or colored letter “L”.

A writing space or box 78 is provided on the instruction side 14 of the card 70. Each writing space 78 may be defined by a box having a color, shading or pattern that is different from the background color of the associated card, and/or may be a box may be defined by lines or the like. In the capital letter cards 70, the writing spaces 78 may lack the lines and coloring of the writing spaces 24 of the lower case letter development cards 10 since capital letters generally lack the x-height portions, ascenders and descenders used in writing lower case letters. Instead, in the capital letter development cards 70, the writing spaces 78 may simply be blocks of space which can be white, yellow, or other colors. The use of yellow on the writing spaces 78 attracts the user's attention, and provides less glare than white paper which decreases visual fatigue. This can be particularly useful for children who are not used to visually focusing on close work (i.e. paper and pencil tasks) for long periods of time. However, various other fill colors besides yellow, such as rose, light blue or the like may be utilized. Spacers 80 may be provided between the writing spaces to teach a user proper spacing of the written letters/numbers.

A traceable version of the letter 42, with associated directional 44 and numerical 46 cues, may be provided on one of the writing spaces/boxes 78. Starting cues 44, 46 may also be provided in the “blank” (but perhaps colored, patterned, etc.) writing spaces 78. These cues 44, 46 are positioned to avoid letter reversals in that the placement of the cues 44, 46 forces the user to write the letter in the proper direction. Writing a letter in the reversed direction, when following the starting cues 44, 46, would cause the letter to stray beyond the vertical borders or other defined area of the writing space 78.

The instruction indicia 40 includes ordered steps and associated narrative text 48. The narrative text 48 for the card 70 shown in FIG. 15 includes the text “Draw a Stick Boy straight and tall” next to the ordered step “1.” This text obviously implies/instructs a user to draw a vertical line, and therefore corresponds to, and reinforces the first step of writing for letter “L”. Step “2” of the narrative text 48, “Put shoes on the Stick Boy” implies a horizontal structure at the bottom of the letter (since shoes are typically located on the ground), thereby supporting the associated horizontal line drawing step. Moreover, the ordered step “1” of the instruction indicia 40, and the vertical portion of the traceable version 42 of the letter “L” may each be printed in red to link those comments. The ordered step “2” and the horizontal portion of the traceable version 42 of the letter “L” may be similarly linked, such as by the color green.

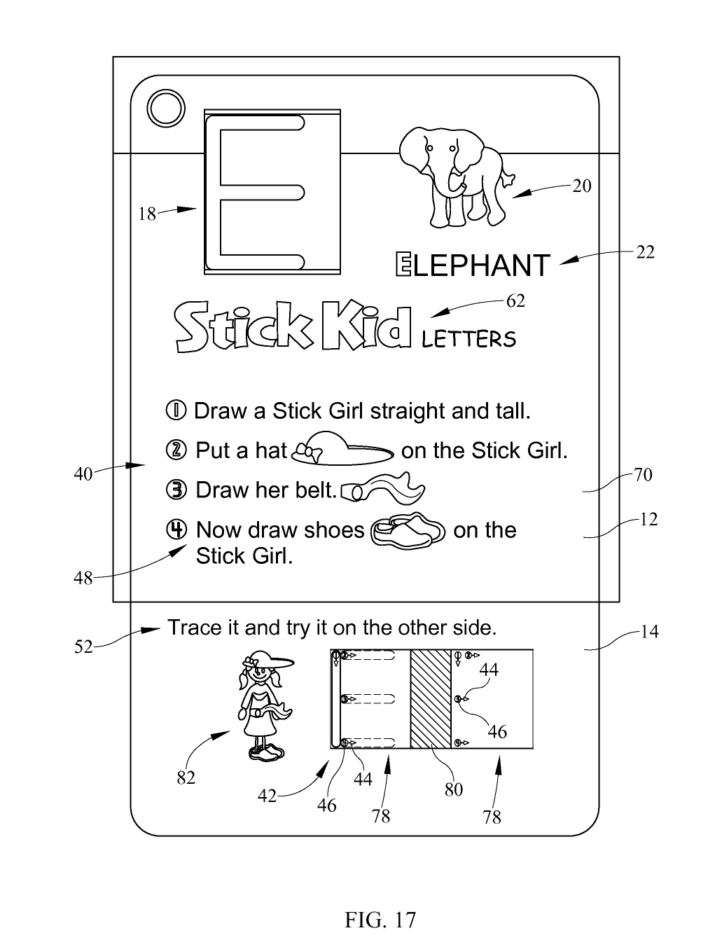

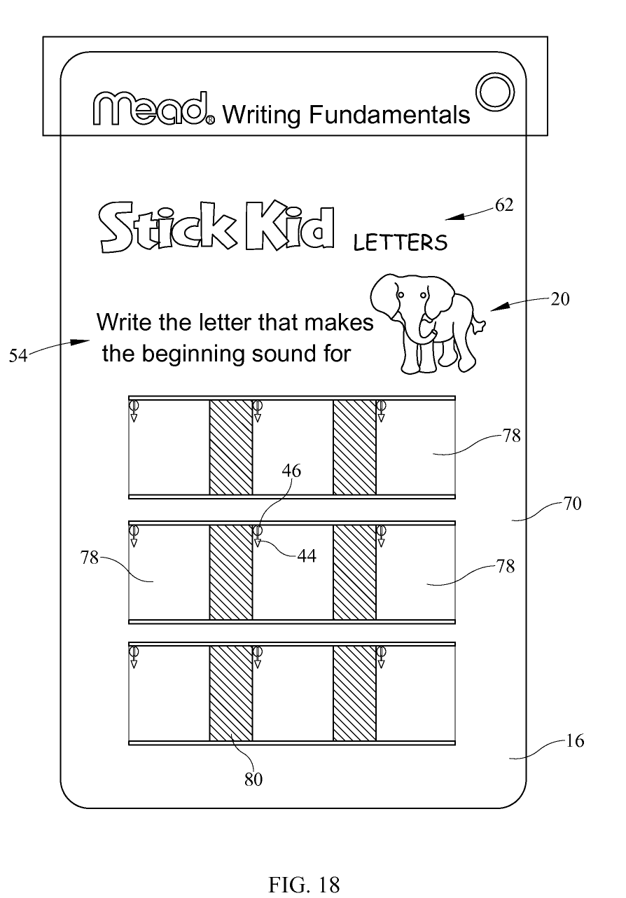

The narrative text 48 may describe the creation of a non-letter (and non-number) object, or may describe activity that generally corresponds to the letter or number. For example, in the embodiment of FIGS. 15 and 16, the non-letter object is a “Stick Kid” having a vertically oriented torso and horizontally-oriented feet/shoes that collectively generally corresponds to the letter “L.” In the embodiment of FIGS. 17 and 18, the non-letter object is a “Stick Girl” having a vertically oriented torso, a horizontally-oriented hat, a horizontally-oriented belt and horizontally-oriented feet/shoes and collectively corresponding generally to the letter “E.” Each capital letter development card 70 may include the visual representation 82 of the non-letter object printed thereon to further reinforce the narrative text 48 and instruction indicia 40.

Once the user has written/traced the letter or number on the traceable version 42 as guided by the instruction indicia 40, the user can utilize the blank writing space 78 provided adjacent to the traceable version 42 to write the letter. Directional cues 44 and associated numbers 46 may be provided on the “blank” writing space 78. Finally, the instruction side 14 of each card 70 may include encouragement indicia 52 to encourage the user to try writing the letter on the opposite side 16 of the card 70.

The challenge side 16 of each card 70 may include question/challenge indicia 54 relating to the identification of the letter/number in the same or similar manner as with the lower case letter development cards 10 described above. The challenge side 16 of each card 70 also includes a plurality of writing spaces 78 upon which the user is cued to write the appropriate letter. In the illustrated embodiment, the writing spaces 78 on the challenge side 16 of the card 70 include directional 44 and numerical 46 cues (or at least the initial cues 44, 46), but lack the instruction indicia 40 or any traceable version 42 or other identification of the associated letter. Thus, cards 70 presenting all of the capital letters of the alphabet can be presented and reviewed in the same manner as the lower case letter development cards 10 as outlined above.

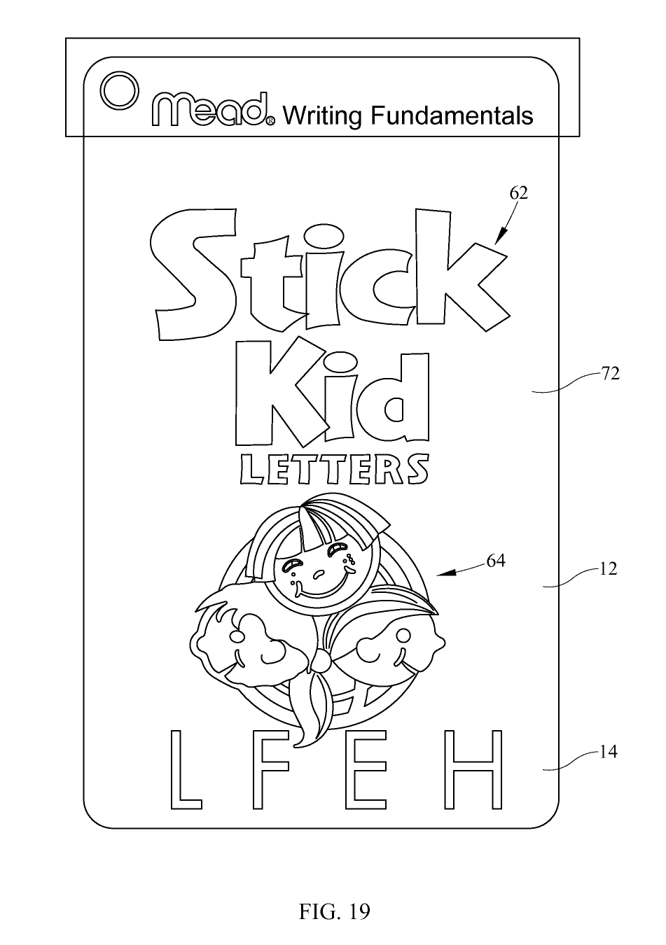

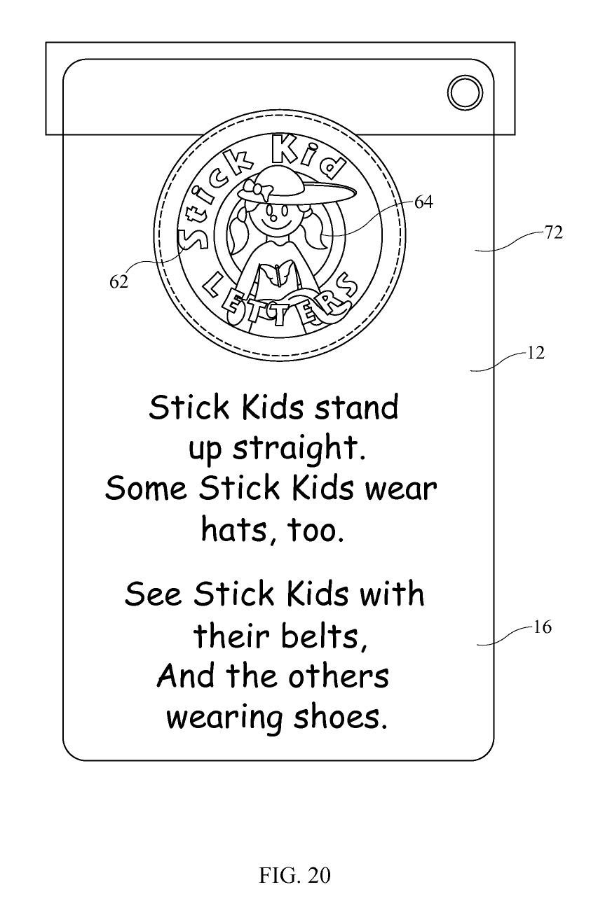

The upper case letter guide cards/letters may be grouped into groupings having common characteristics or written using similar motor patterns. For example, FIGS. 19 and 20 illustrate a grouping card 72 which introduces the letters in that grouping. In the embodiment of FIG. 19, the grouping includes the letters L, F, E and H and is termed the “stick kid” letters. All of the letters in the “stick kid” grouping consist exclusively of horizontal and vertical lines, and thus can be taught using similar techniques and are made of similar pre-writing shapes or parts thereof. The back side 16 of each capital letter grouping card 72 may include text or other indicia that describes some characteristics of the letters in that group. The grouping card 72 includes a title 62 and symbol 64 which can be used on the associated letter development cards 70 as described above in the context of the grouping cards 50 for the lower case letter development cards 10.

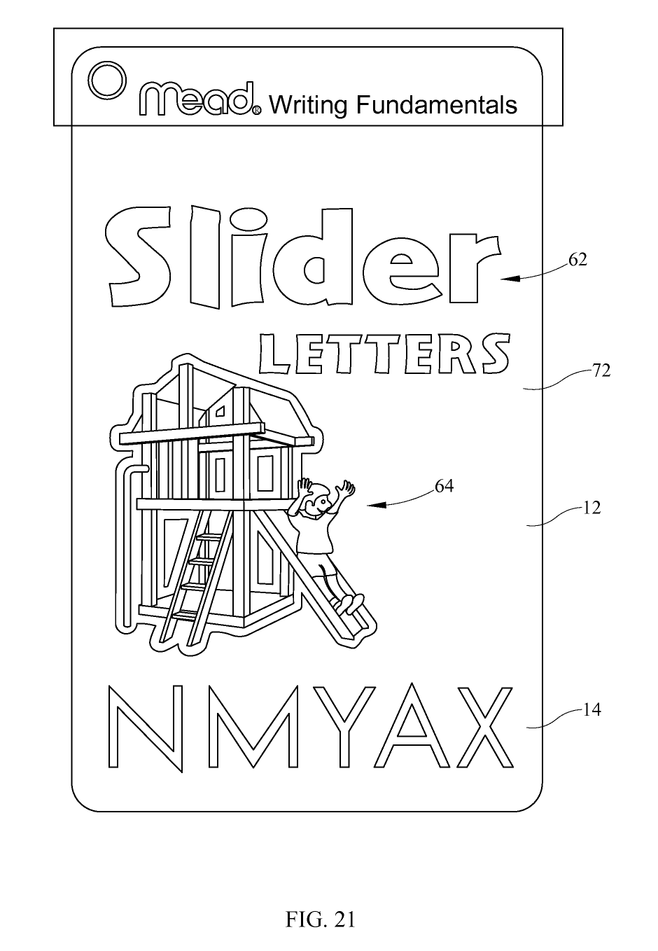

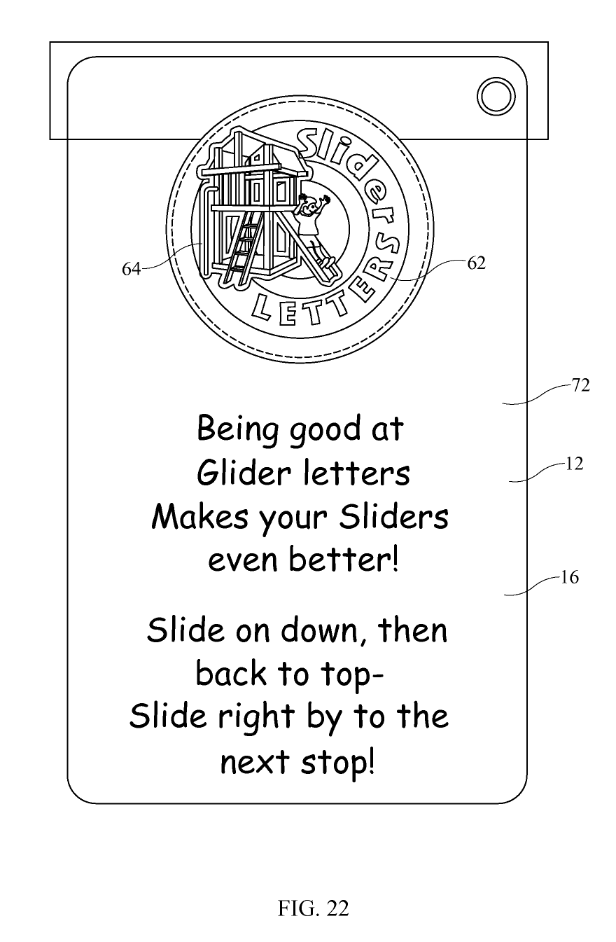

FIGS. 21 and 22 illustrate a grouping card 72 which introduces the letters in another grouping termed the “slider” letters, including the letters N, M, Y, A and X. All of the letters in this grouping include angled or oblique lines, and thus can be taught using similar technique and without having to lift the writing instrument off of the paper.

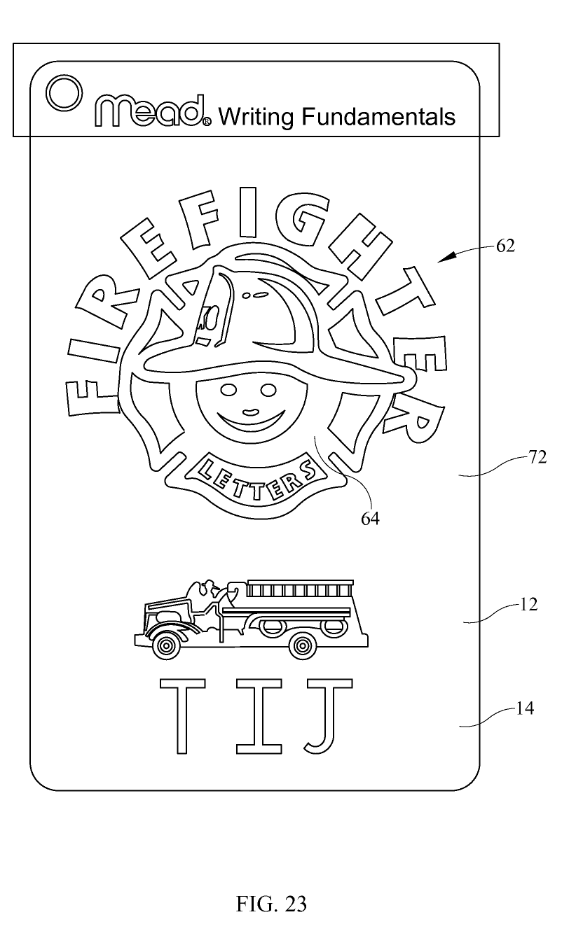

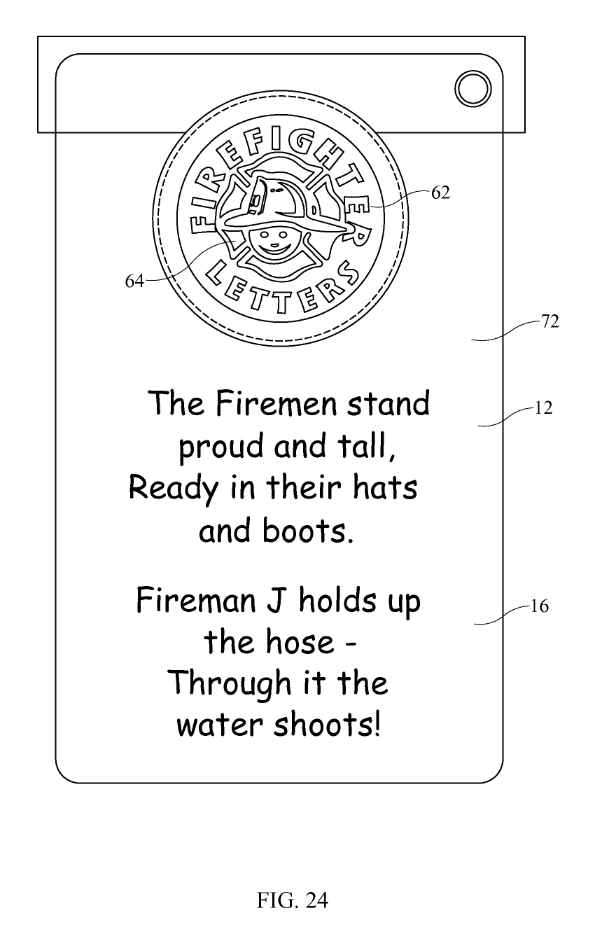

A total of eight groupings may be utilized. The first grouping, as described above, consists of letters (L, F, E and H) made up of vertical and horizontal lines. The second grouping consists of the letters T, I and J (shown in FIGS. 23 and 24). This grouping may be termed the “firefighter” letters and consists of letters made of vertical and horizontal lines, with the addition of a curve for the letter J.

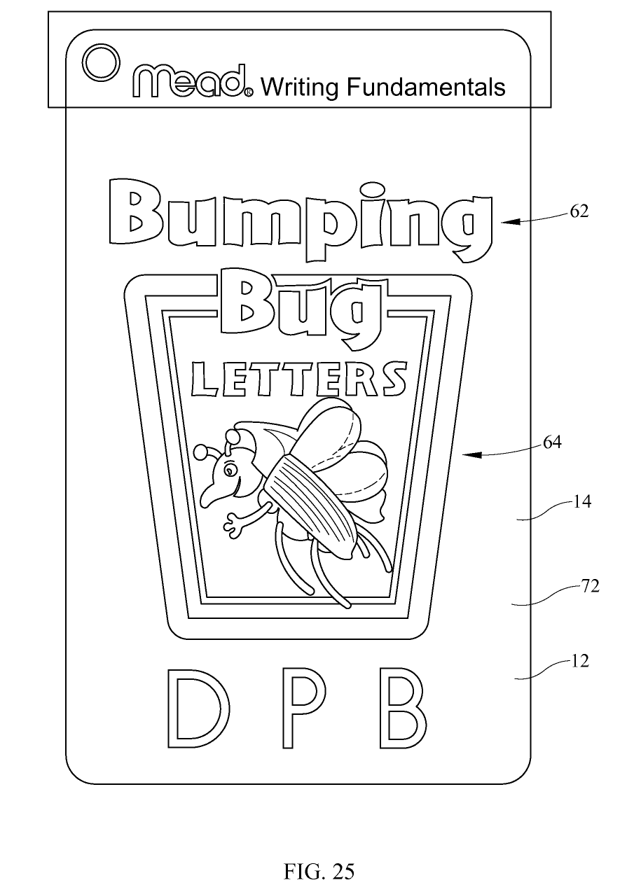

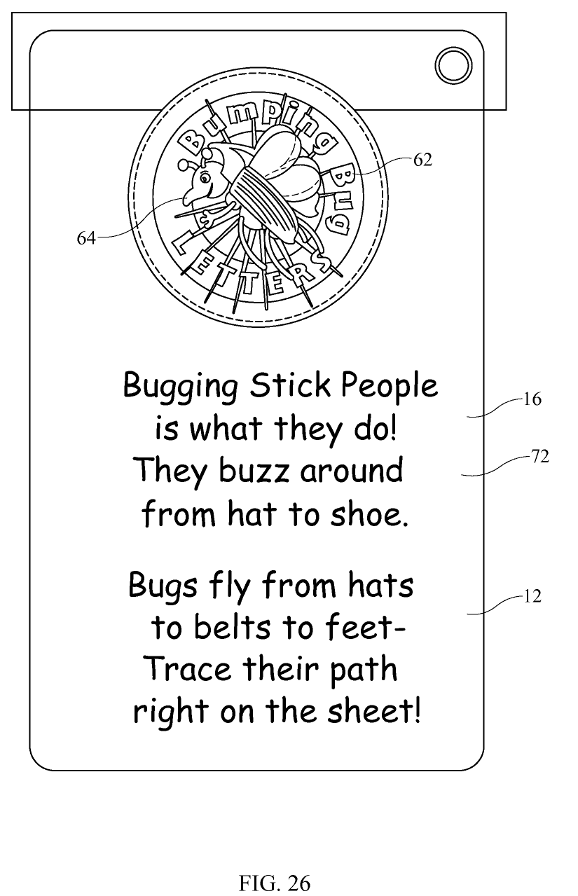

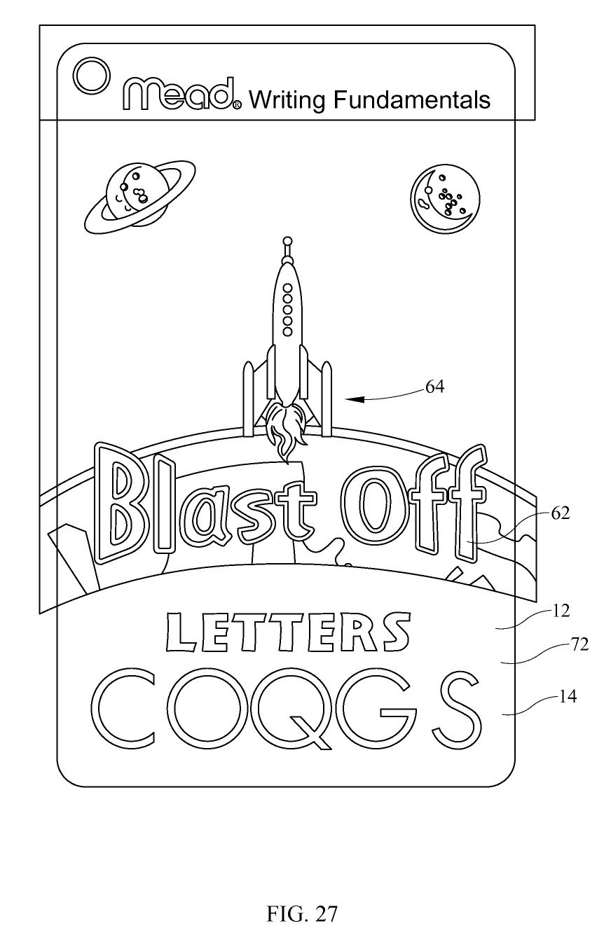

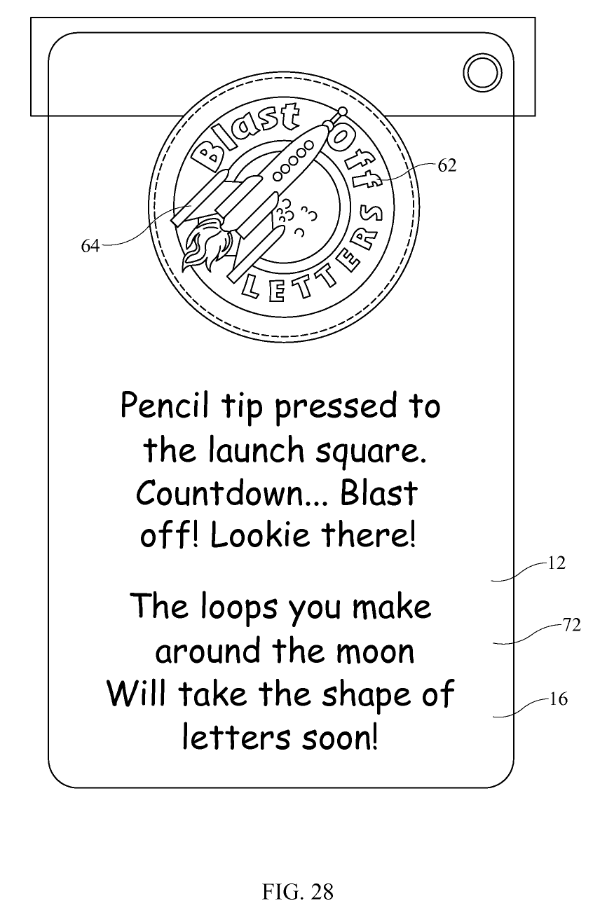

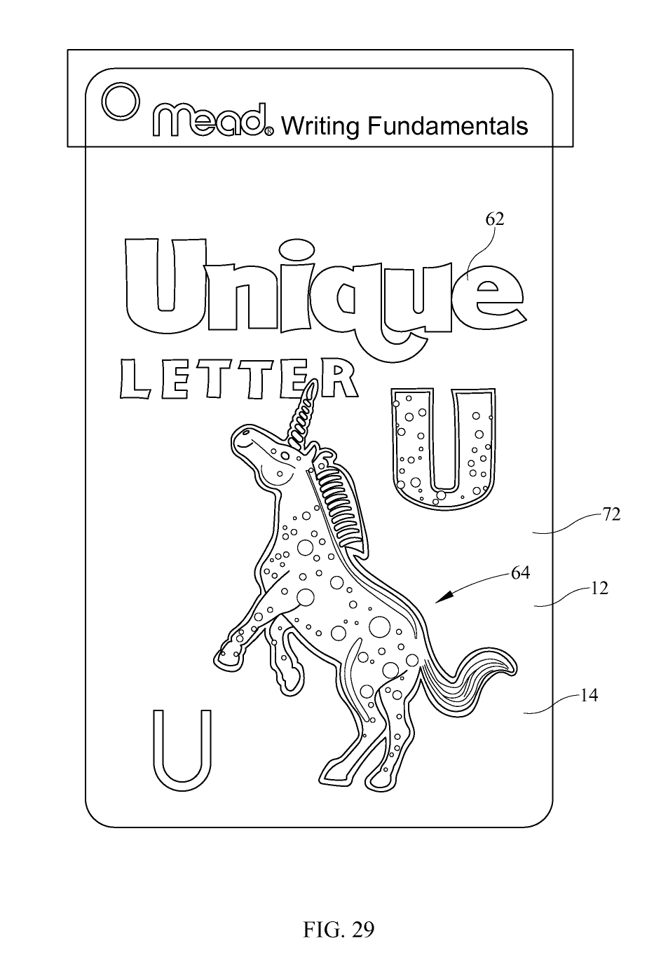

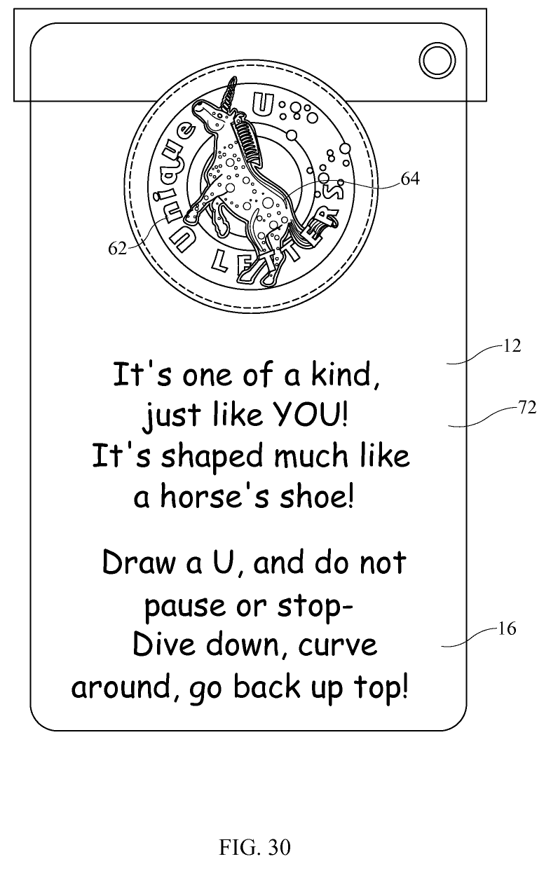

The third grouping consists of the letters D, P and B (FIGS. 25 and 26), and may be termed the “bumping bug” letters. The letters in the third grouping use vertical lines and also incorporate curves more prominently than the second grouping. The fourth grouping (FIGS. 27 and 28) consists of the letters C, O, Q, G and S and may be termed the “blast off” letters. The letters in this grouping predominately incorporate curves and also utilize a right oblique shape in the letter Q. The fifth grouping (FIGS. 29 and 30) consists of the letter U, and may be termed “unique U.” The letter in the fifth grouping is written with a vertical line and curve combined with a change in direction.

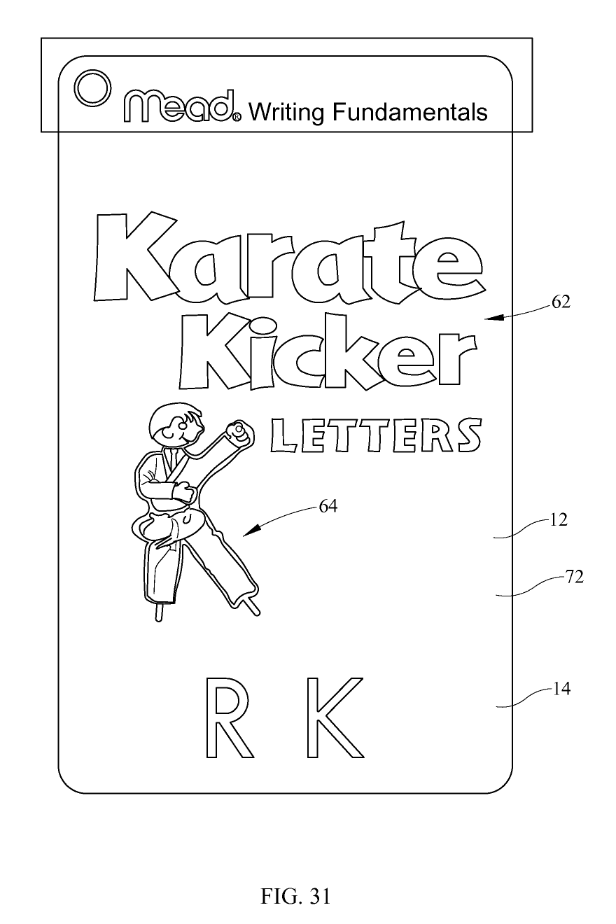

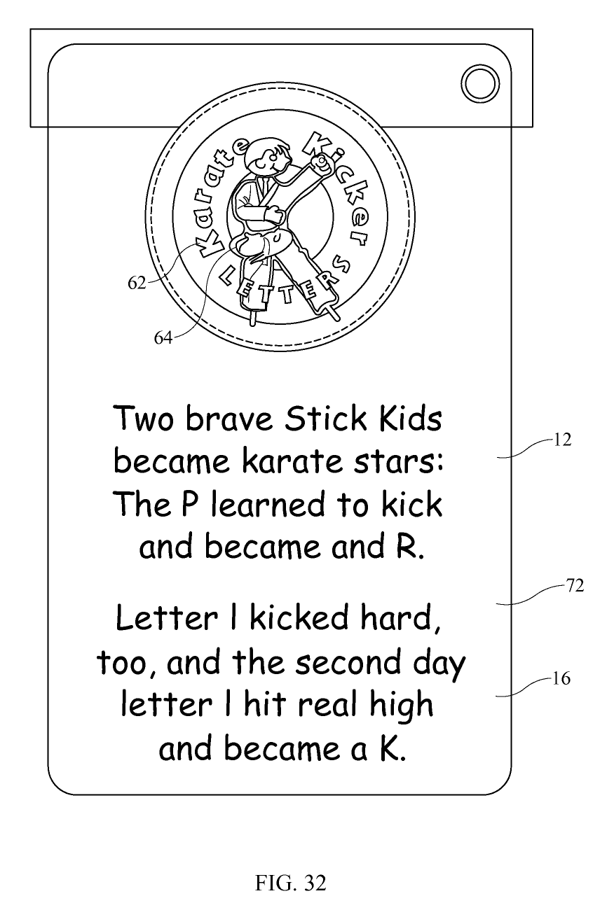

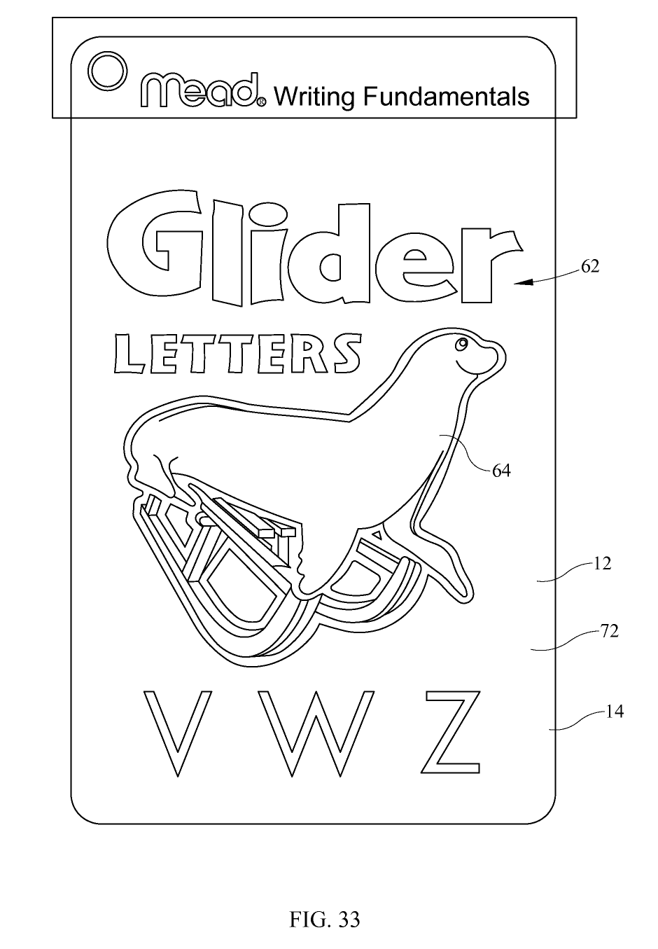

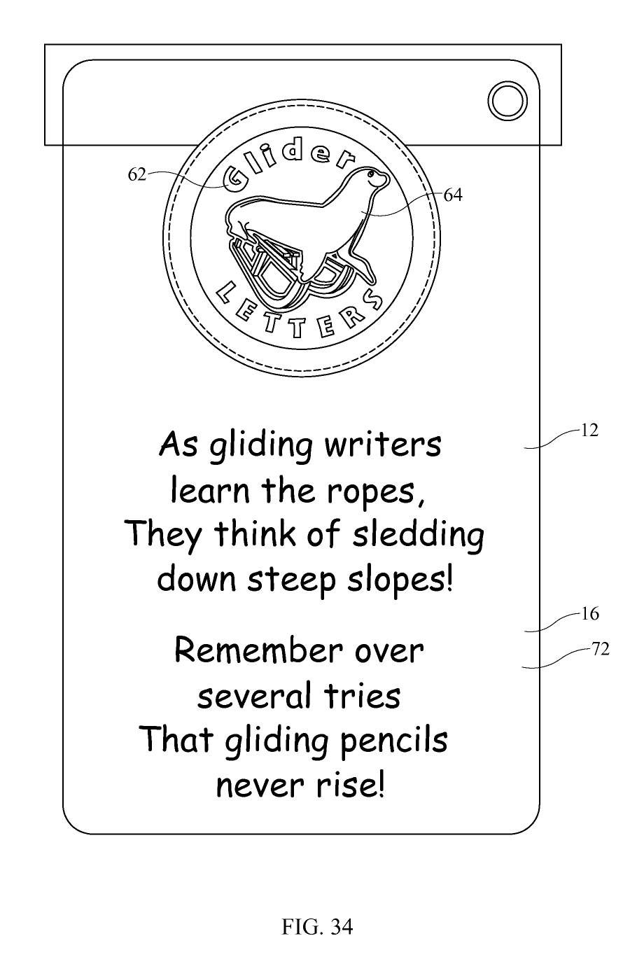

The sixth grouping (FIGS. 31 and 32) consists of the letters R and K, and may be termed the “karate kickers” group. The letter in this group are written with the three components of vertical lines, curves and diagonals. The seventh grouping (FIGS. 33 and 34) consists of the letters V, W and Z, and may be termed the “gliders” letters. The letters in this group are written with horizontal lines and obliques without lifting the writing instrument off of the writing surface. The eighth and final grouping consists of the letters N, M, Y, A and X (FIGS. 21 and 22), may be termed the “sliders” group and is described above. This letters in this group are written using vertical lines, horizontal lines, obliques and adjacent obliques, as seen in the triangle for the letter A. Moreover, in order to properly write the letters in this grouping the writing instrument must be lifted off of the writing surface one or two times. These letter groupings are based on similar motor patterns and developmental progression of pre-writing shapes as identified in the Development Test of Visual Motor Integration (“VMI”), a widely-used standardized assessment.

The cards 70/72 may be arranged, and/or a user may be instructed, to work through each grouping in the order presented above. The groupings may be arranged in this order to present progressively more challenging groupings to a user, and to allow a user to develop basic writing skills before adding more sophisticated writing skills to the skills required by the previous grouping. Alternately, the cards 70/72 and/or groupings may be worked through in varying orders to provide a challenged to the user. The cards 70/72 (and other cards described and shown herein) may be packaged for sale along with a set of instructions that instruct a user (or a user's parents, teachers, etc.) to use the cards 70/72 in the manner described herein.

Various cards, having the features described above, may also be used to teach writing skills for numbers. For example, the instruction indicia 40 may relate to the writing strokes for writing a number. In this case, a user may be cued, by the challenge side of the card, to write the appropriate number by indirect indicia (i.e. asking a user to count items, complete a simple match problem, etc.)

Proper writing habits includes making vertical and diagonal lines from top-to-bottom, making circles from the top and counterclockwise toward the left, and making horizontal lines from left-to-right. Teaching a user to develop these habits prepares a child for proper letter writing. Moreover, learning to follow a visual sequence is important in learning to follow multi-step directions. In addition learning a particular sequence in shape and letter writing can increase legibility and writing fluency (speed and accuracy). Finally, learning to use various lines and curves to construct an object, especially learning to use continuous strokes (rather than unnecessarily lifting the writing instrument) further aides the user in the development of the underlying skills needed for proper letter and number formation. Since the user is cued to the starting point of the letter, it is difficult for a user to reverse the letter orientation. The cards test, reinforce and teach (if necessary) these skills, and also teach the ability to write within boundaries and the directionality of letter formation.

Having described the invention in detail and by reference to the various embodiments, it should be understood that modifications and variations thereof are possible without departing from the scope of the invention.

What is claimed is:

1. A card set including a plurality of letter or number development cards, each card including opposed instruction and challenge sides, each instruction side having instruction indicia relating to the writing of a particular letter or number associated with the card, each challenge side having visual indicia which indirectly identifies the particular letter or number and cues the user to write the particular letter or number, wherein the challenge side of the card lacks any indicia that directly identifies which particular letter or number is associated with the card.

2. The card set of claim 1 wherein the visual indicia phonetically cues a user as to the identity of the particular letter.

3. The card set of claim 1 wherein the visual indicia relates to an item, or an action, or a place, or a concept having a name or title that begins with the particular letter.

4. The card set of claim 1 wherein the instruction side includes indicia allowing a user to check whether the particular letter or number written on the challenge side was correctly written, and wherein the challenge side of the card lacks any indicia that directly identifies or models the particular letter or number.

5. The card set of claim 1 wherein the challenge side includes a writing space thereon, and further includes a starting cue which cues a user as to the location for the initial placement of a writing instrument relative to the writing space for writing the particular letter or number on the writing space.

6. The card set of claim 5 wherein the starting cue cues a user as to the direction for an initial writing stroke for writing the particular letter or number.

7. The card set of claim 1 wherein at least one of the instruction or challenge sides includes a writing space thereon such that a user can write the particular letter or number on said writing space.

8. The card set of claim 7 wherein said challenge side includes indicia cuing a user to check the vertical alignment of the particular letter relative to said writing space.

9. The card set of claim 8 wherein said writing space includes at least three generally parallel spaced apart lines defining first and second portions therebetween such that a user can write on the first and second portions while using the spaced lines to guide the writing thereof, wherein the first portion is of a first color and the second portion is of a second color different from the first color, the first portion being positioned on top of the second portion, wherein the first color is blue or green and the second color is green or brown, and wherein said second side includes indicia cuing a user to check the positioning of the particular letter on said writing space, wherein said check indicia relates to the positioning of said particular letter in said portions of said writing space.

10. The card set of claim 7 wherein said writing space includes vertical borders, a contrasting color, and a starting cue which cues a user as to the location for the initial placement of a writing instrument relative to the vertical borders to cue a user to write the particular letter or number to minimize letter or number reversals.

11. The card set of claim 1 wherein the set includes at least one letter development card directed to each letter of the alphabet, and wherein the set includes grouping indicia which groups each letter with other letters of the alphabet.

12. The card set of claim 11 wherein each of the twenty-six lowercase letters of the English alphabet into are formed into groupings having common characteristics, including a first grouping consisting of the letters c, o, s, v, x, w and z, a second grouping consisting of the letters l, t, i, j and k, a third grouping consisting of the letters a, d, g and q, a fourth grouping consisting of the letters r, n, m, p, h and b, and a fifth grouping consisting of the letters f, e, u and y.

13. The card set of claim 11 wherein each of the twenty-six uppercase letters of the English alphabet into are formed into groupings having common characteristics, including a first grouping consisting of the letters L, F, E and H, a second grouping consisting of the letters T, I and J, a third grouping consisting of the letters D, P and B, a fourth grouping consisting of the letters C, 0, Q, G and S, a fifth grouping consisting of the letter U, a sixth grouping consisting of the letters R and K, a seventh grouping consisting of the letters V, W and Z, and an eighth grouping consisting of the letters N, M, Y, A and X.

14. The card set of claim 13 wherein the groupings are arranged with respect to the complexity of visual motor integration skills required to properly write the letters in the associated grouping.

15. The card set of claim 1 wherein the set includes at least one letter development card directed to each letter of the alphabet, and wherein the set includes a plurality of letter grouping cards, each letter grouping card including indicia grouping some letters of the alphabet into a grouping associated with that particular letter grouping card, and wherein each letter of the alphabet is included in one of the groupings.

16. The card set of claim 1 wherein the instruction indicia includes narrative indicia, the narrative indicia having discrete portions that describe an object or activity that is symbolic of the associated step for writing the particular letter or number.

17. The card set of claim 1 wherein the instruction side of each card includes numerical and directional cues thereon which cue a user as to the proper writing strokes for writing the particular letter or number.

18. The card set of claim 1 wherein said instruction side include indicia which directly identifies the particular letter or number.

19. A card assembly comprising:
a plurality of cards, each card having sequential instruction indicia instructing a user to write a single particular letter, wherein the plurality of cards collectively include sequential instruction indicia relating to all twenty-six lower case letters of the English alphabet, wherein the assembly groups the letters into groupings having common characteristics, including a first grouping consisting of the letters c, o, s, v, x, w and z, a second grouping consisting of the letters l, t, i, j and k, a third grouping consisting of the letters a, d, g and q, a fourth grouping consisting of the letters r, n, m, p, h and b, and a fifth grouping consisting of the letter f, e, u and y.

20. A card assembly comprising:
a plurality of cards, each card having sequential instruction indicia instructing a user to write a single particular letter, wherein the plurality of cards collectively include sequential instruction indicia relating to all twenty-six capital letters of the English alphabet, wherein the plurality of cards group the letters into groupings having common characteristics, including a first grouping consisting of the letters L, F, E and H, a second grouping consisting of the letters T, I and J, a third grouping consisting of the letters D, P and B, a fourth grouping consisting of the letters C, O, Q, G and S, a fifth grouping consisting of the letter U, a sixth grouping consisting of the letters R and K, a seventh grouping consisting of the letters V, W and Z, and an eighth grouping consisting of the letters N, M, Y, A and X.

21. A card assembly comprising:
a card;
sequential instruction indicia on the card, the sequential instruction indicia including discrete ordered steps that cue a user in writing strokes to write a single particular letter or number; and
narrative indicia on the card having discrete portions that correspond to the discrete ordered steps of the sequential instruction indicia.

22. The card assembly of claim 21 wherein there is a one-to-one correspondence between the discrete ordered steps of the instruction indicia and the discrete portions of the narrative indicia.

23. The card assembly of claim 21 wherein the sequential instruction indicia includes directional cues that are positioned on or adjacent to a traceable version of the letter or number.

24. The card assembly of claim 21 wherein each discrete portion of the narrative indicia is associated by color with a discrete ordered step of the sequential instruction indicia.

25. The card assembly of claim 21 further comprising a plurality of cards coupled, or bound, or packaged together, and wherein the plurality of cards collectively include sequential instruction indicia and associated narrative text relating to all twenty-six letters of the English alphabet.
